(19) United States
(12) Patent Application Publication
(10) Pub. No.: US 2011/0119047 A1
(43) Pub. Date: May 19, 2011

(54) Joint disambiguation of the meaning of a natural language expression

(75) Inventor: Tatu J. Ylonen, Espoo (FI)

(73) Assignee: TATU YLONEN OY LTD, Espoo (FI)

(21) Appl. No.: 12/622,272

(22) Filed: Nov. 19, 2009

(51) Int. Cl. G06F 17/27

(52) U.S. Cl. 704/9

(57) ABSTRACT

At least two ambiguous aspects of the meaning of a natural language expression are disambiguated jointly. In the preferred embodiment, word sense ambiguity, reference ambiguity, and relation ambiguity are resolved simultaneously, finding the disambiguation result(s) that simultaneously optimize the weight of the solution, taking into account semantic information, constraints, and common sense knowledge. Choices are enumerated for each constituent being disambiguated, combinations of choices are constructed and evaluated according to semantic information on which meanings are sensible, and the choices with the best weights are selected, with the enumeration pruned aggressively to reduce computational cost.

### CROSS-REFERENCE TO RELATED APPLICATIONS

Not Applicable

### INCORPORATION-BY-REFERENCE OF MATERIAL SUBMITTED ON ATTACHED MEDIA

Not Applicable

### TECHNICAL FIELD

The present invention relates to computational linguistics, particularly to disambiguation of ambiguities in connection with semantic parsing of natural language.

### BACKGROUND OF THE INVENTION

When computers interpret natural language, selecting the correct interpretation for a natural language expression is very important.

Despite extensive research on meaning representation spanning five decades, there still is no universally accepted method of representing sentence meanings, much less constructing them. Only partial solutions exist for disambiguating natural language expressions and for reference resolution. Improvements leading to more robust disambiguation and reference resolution, and thus better and more robust ways of constructing semantic representations of natural language expressions, are in great need. Such improvements could enable breakthroughs in, e.g., machine translation, search, information extraction, spam filtering, computerized assistance applications, computer-aided education, and many other applications intelligently processing information expressed in natural language, including the control of robots and various home and business appliances.

Shortcomings of existing reference resolution approaches are discussed in Marjorie McShane: Reference Resolution Challenges for an Intelligent Agent: The Need for Knowledge, draft accepted for future publication in IEEE Intelligent Systems, 2009 (DOI 10.1109/MIS.2009.85, printed Nov. 9, 2009).

A conventional reference resolution architecture for resolving anaphoric references is described in D. Cristea et al: Discourse Structure and Co-Reference: An Empirical Study, Proceedings of the Workshop The Relation of Discourse/Dialogue Structure and Reference, pp. 46-53, Association for Computational Linguistics (ACL), 1999.

A reference and presupposition resolution method is described in R. Kasper et al: An Integrated Approach to Reference and Presupposition Resolution, Proceedings of the Workshop The Relation of Discourse/Dialogue Structure and Reference, pp. 1-10, Association for Computational Linguistics (ACL), 1999. Groups of referents are resolved in A. Denis et al: Resolution of Referents Groupings in Practical Dialogues, pp. 54-59 in Proc. 7th SIGdial Workshop on Discourse and Dialogue, Association for Computational Linguistics (ACL), 2006.

Word sense disambiguation has been recently surveyed in R. Navigli: Word Sense Disambiguation: A Survey, Computing Surveys, 41(2), pp. 10:1-10:69, February 2009.

The prior art mostly treats word sense disambiguation and reference resolution as separate problems (separate steps in a language processing pipeline). Disambiguation is usually performed for individual words or certain fixed multi-word expressions (compound words, phrasal verbs, and idioms). Many disambiguation systems use features computed from the surrounding context or the entire document to aid in the disambiguation decision. Some use selectional restrictions of verbs, using shallow semantic features (i.e., boolean flags such as “+animate”) to constrain acceptable subjects, objects, and other constituents of verb phrases based on the main verb. Such boolean semantic features are not sufficient for representing the meaning of a natural language expression. Some systems use unification to implement constraints in the grammar in a similar manner, with features associated with each word in the lexicon.

A few systems analyze hypergraphs of word senses based on semantic distance metrics (e.g., M. Galley et al: Improving word sense disambiguation in lexical chaining, IJCAI'03, IJCAI, 2003, pp. 1468-1488).

A system disambiguating both word senses and relations (as separate problems) is described in R. Porzel et al: Making Relative Sense: From Word-graphs to Semantic Frames, pp. 41-48, 2nd International Workshop on Scalable Natural Language Understanding (ScaNaLu), Association for Computational Linguistics (ACL), 2004. Local syntactic patterns are disambiguated in I. Nica et al: Combining EWN and Sense-Untagged Corpus for WSD, CICLing 2004, LNCS 2945, Springer-Verlag, 2004, pp. 188-200.

A few authors have modeled morphological-syntactic interaction in a generative probabilistic framework or used joint probabilistic inference to perform joint morphological and syntactic disambiguation for Semitic languages. Such work includes Y. Goldberg et al: A Single Generative Model for Joint Morphological Segmentation and Syntactic Parsing, ACL-08: HLT, pp. 371-379, Association for Computational Linguistics (ACL), 2008; S. Cohen et al: Joint Morphological and Syntactic Disambiguation, EMNLP-CoNLL'07, pp. 208-217, Association for Computational Linguistics (ACL), 2007; and R. Tsarfaty: Integrated Morphological and Syntactic Disambiguation for Modern Hebrew, COLING/ACL 2006 Student Research Workshop, pp. 49-54, 2006.

Using statistical machine learning approaches for meaning construction from natural language expressions has been an active research topic during the last decade. Recent papers include: L. Zettlemoyer et al: Learning Context-dependent Mappings from Sentences to Logical Form, in Proceedings of the Joint Conference of the Association for Computational Linguistics and International Joint Conference on Natural Language Processing (ACL-IJCNLP), 2009; R. Ge et al: Learning a Compositional Semantic Parser using an Existing Syntactic Parser, in Proceedings of the 47th Annual Meeting of the ACL and the 4th IJCNLP of the AFNLP, 2009, pp. 611-619; and C. Thompson & R. Mooney: Acquiring Word-Meaning Mappings for Natural Language Interfaces, Journal of Artificial Intelligence Research, 18:1-44, 2003.

An overview of knowledge representation methods can be found in R. Brachman et al: Knowledge Representation and Reasoning, Elsevier, 2004. Detailed treatments of semantic networks can be found in J. F. Sowa: Conceptual Structures: Information Processing in Mind and Machine, Addison-Wesley, 1984; J. F. Sowa: Principles of Semantic Networks: Explorations in the Representation of Knowledge, Morgan Kaufmann, 1991; and H. Helbig: Knowledge Representation and the Semantics of Natural Language, Springer, 2006.

The above mentioned references are hereby incorporated herein by reference in their entirety.

### BRIEF SUMMARY OF THE INVENTION

To begin with an example, imagine “a child running to a bank”. However, if “it ran along the bank”, the bank is probably something quite different. “Money is running to the bank”, “it was running down his face”, and “water ran to the bank” all mean something quite different. But what does “it ran there” mean?

It is difficult to disambiguate/resolve any of “it”, “ran”, or “there” alone. Each of them can have multiple alternative meanings or referents, depending on the context. The selection of the proper meaning for each requires deep understanding of the context in which the sentence was used, to determine what each of the words means. Even then, it may be impossible to select the appropriate meanings for the words independently. Choice of a meaning for one word may affect the meaning of another. Known conventional solutions for disambiguating the meaning have mostly addressed disambiguating individual words.

The present invention is about disambiguating the meaning of a natural language expression. The meaning refers to the message the speaker (or writer) wanted to convey to the recipient, or more precisely, the internal representation within a computer thereof.

According to an embodiment of the invention, at least two ambiguous aspects of the meaning of a natural language expression are disambiguated jointly. This means that interpretation choices for each ambiguous aspect are considered simultaneously, and are evaluated for their compatibility, preferably using semantic information.

Categories of ambiguous aspects may include:
word senses, including senses of multi-word expressions (which are usually treated as one word in the lexicon)
referents of noun and verb phrases
interpretation of relations (whether indicated in natural language by prepositions, inflection, word order, or otherwise)
interpretation of determiners (e.g., “the” can be used to refer to a previously mentioned individual, shared knowledge, generally known entities, classes/groups of individuals (“the Canadians”), indicate restrictive postmodification, etc.

The ambiguous aspects of the meaning may belong to one or more of these categories, and ambiguous aspects from more than one category may be resolved jointly.

In the preferred embodiment, at least one of the ambiguous aspects is the referent of a referring expression (i.e., it is ambiguous what object/entity the referring expression refers to). Such references may refer to, e.g., already mentioned entities and activities in the discourse context, the shared knowledge of the participants to the discourse (e.g., “the MPEP”), or to generally known entities in particular cultures (e.g., “Bush senior” or “the Sun”).

An embodiment of joint disambiguation is illustrated in FIG. 5. At least two ambiguous constituents (402,403) are obtained from a parse context. Enumerators (501,502) are used to enumerate choices for each constituent. There are several kinds of enumerators (see FIG. 1), such as a word sense enumerator (116), a reference enumerator (117), and a relation enumerator (118). A number of choices (503, 504) are generated for each constituent. Combinations of the choices (505) are generated by a combinator (119). The weight for each combination is evaluated by a semantic evaluator (120). This results in a number (zero or more) of combinations with a posteriori weights (506). The desired number of best choices are then selected and parse contexts are created for them (constructing the disambiguated representation as appropriate in each embodiment) (507). The improvement in this embodiment over the prior art comprises that it generates combinations of choices, and evaluates the weight for combinations of choices for more than one ambiguity, as opposed to individual choices in conventional reference resolution.

The semantic representation of a natural language input is advantageously constructed in phases. First, a non-disambiguated representation is constructed, then the ambiguities in the representation are jointly disambiguated, and finally one or more disambiguated representations are constructed.

The application of joint disambiguation is preferably controlled by a grammar, and the grammar triggers when to disambiguate. Preferably disambiguation is performed at clause level, but may also be performed at, e.g., noun phrase level (especially for complex noun phrases involving postmodifying clauses), verb phrase level, or sentence level. The semantic representation can then be constructed incrementally by repeating the phases for successively larger representations.

Prior art has been mostly concerned with disambiguating the meaning of individual constituents (or words) independent of the meaning of other constituents in the same natural language expression. Reference resolution, for instance, is conventionally performed one word at a time, making it impossible for the system to properly understand expressions like “he saw him”, or “it did it”.

Recent work on Hebrew parsing has investigated using joint statistical inference for jointly disambiguating the morphology and syntax of Hebrew sentences (Goldberg et al (2008), Cohen et al (2007), and Tsarfaty (2006)). That work differs from the present invention in that they are only disambiguating the form (i.e., word forms, or stems, occurring in the input, and the syntax (parse tree) of the input). Their probabilistic model does not generalize to meaning disambiguation, because the set of candidate referents for constituents is dynamically changing and there is an unlimited number of possible forms for constituents (e.g., noun phrases, including restricting adjectives, prepositional phrases, and restricting relational phrases) whose referent may need to be disambiguated. Even if a model for handling the dynamic change could be constructed, there would never be enough training data available to learn parameters of the model for all possible constituents and referents.

Galley (2003) disambiguates all words of a document simultaneously using shallow semantic information, forcing the same word sense to be used for all instances of the same word in a document. It cannot, for example, be used to properly interpret “That man is no man”, because it cannot disambiguate two constituents having the same surface form (same word) to different meanings. It does not address reference resolution at all.

Kasper (1999) uses multiple criteria for selecting the referent, but seems to disambiguate only a single constituent at a time.

Disambiguating the meaning is a key component of deep semantic interpretation of a natural language expression, as opposed to shallow parsing, which mostly concerns itself with form (syntax, statistical information). Meaning disambiguation involves entirely different issues from form or syntax disambiguation (such as selecting referents for referring expressions). One could also argue that in most actual natural language applications, knowing the syntax or form is not important at all; instead, understanding the meaning of the expression (the intended meaning by the speaker, not necessarily the literal meaning) is the key.

The disambiguation methods disclosed herein are particularly important for deep semantic interpretation of natural language, but are also useful in shallow interpretation. Typical industrial applications for natural language interpretation include question answering systems, information retrieval systems, machine translation, text mining, computer-aided education, phone help systems, and voice control of home and office appliances, robots, vehicles, and other machines.

A first aspect of the invention is a method comprising:
jointly disambiguating, by a computer, more than one ambiguous aspect of the meaning of a natural language expression;
   wherein at least one of the ambiguous aspects relates to determining the referent of a constituent of the natural language expression.

A second aspect of the invention is a method comprising:
reading and preprocessing, by a computer, a natural language expression from an input;
parsing, by the computer, the natural language expression or part thereof, creating a preliminary semantic representation of its meaning, said representation comprising more than one ambiguity;
disambiguating, by the computer, ambiguities in the preliminary semantic representation; and
constructing, by the computer, a semantic representation of the meaning of the natural language expression, wherein at least some of the ambiguities of the preliminary semantic representation have been resolved;
   wherein the improvement comprises performing the disambiguation by jointly disambiguating more than one of the ambiguities.

The cited elements of known systems are obviously present in many embodiments of the present invention, but not necessarily in all of them. In some embodiments of the invention, an already parsed input might be received from another computer, in which case the embodiment might not include the reading and parsing steps. In some other embodiments, such as a machine learning application collecting statistics about the way references operate in natural language, a semantic representation of the disambiguated meaning might not be constructed, even though the results of the disambiguation step are used.

A third aspect of the invention is an apparatus comprising:
a joint meaning disambiguator (115) comprising:
   at least one reference enumerator (117);
   at least one combinator (119) coupled to at least one of the reference enumerators for receiving choices from the reference enumerator; and
   at least one semantic evaluator (120) configured to compute a weight for at least one combination generated by at least one of the combinators.

A fourth aspect of the invention is a computer comprising:
a means for parsing a natural language expression; and
a means for jointly disambiguating at least two ambiguous aspects of the meaning of the parsed natural language expression.

A fifth aspect of the invention is a computer program product stored on a tangible computer readable medium, operable to cause a computer to jointly disambiguate more than one ambiguous aspect of the meaning of a natural language expression, the product comprising:
a computer executable program code means for parsing a natural language expression; and
a computer executable program code means for jointly disambiguating more than one ambiguous aspect of the meaning of the parsed natural language expression.

This summary is provided to introduce a selection of concepts in a simplified form that are further described below in the detailed description. This summary is not intended to identify key features or essential features of the claimed subject matter, nor is it intended that this summary be used to limit the scope of the claimed subject matter. Furthermore, the claimed subject matter is not limited to implementations that solve any or all disadvantages noted in any part of this disclosure.

### BRIEF DESCRIPTION OF THE SEVERAL VIEWS OF THE DRAWING(S)

Preferred embodiments of the invention will now be described with reference to the following schematic drawings.

FIG. 1 illustrates a computer according to an embodiment of the invention.

FIG. 2 illustrates construction of a semantic representation of a natural language input by constructing a non-disambiguated representation, performing joint disambiguation, and constructing the disambiguated representation.

FIG. 3 illustrates joint disambiguation.

FIG. 4 illustrates how joint disambiguation can be embodied in a natural language interpretation system.

FIG. 5 illustrates data flow within an embodiment of a joint meaning disambiguator.

FIG. 6A illustrates a robot embodiment of the invention.

FIG. 6B illustrates an appliance embodiment of the invention.

### DETAILED DESCRIPTION OF THE INVENTION

It is to be understood that the aspects and embodiments of the invention described in this specification may be used in any combination with each other. Several of the aspects and embodiments may be combined together to form a further embodiment of the invention, and not all features, elements, or characteristics of an embodiment necessarily appear in other embodiments. A method, a computer, or a computer program product which is an aspect of the invention may comprise any number of the embodiments or elements of the invention described in this specification.

Separate references to “an embodiment”, “one embodiment”, or “another embodiment” refer to particular embodiments or classes of embodiments (possibly different embodiments in each case), not necessarily all possible embodiments of the invention. “First”, “second”, etc. entities refer to different entities, unless otherwise noted. Unless otherwise mentioned, “or” means either or both, or in a list, one or more of the listed items. Subtitles are only intended to aid in reading, not to restrict the content in any way. The subject matter described herein is provided by way of illustration only and should not be construed as limiting.

In this specification, ambiguous means that something has more than one interpretation, meaning, or alternative (together called choices). Disambiguation is the process of selecting one choice from among the many. Non-disambiguated means that something that has not yet been disambiguated and may thus have more than one choice. Disambiguated means that something is not ambiguous (but may have been originally), or is less ambiguous than it originally was.

Partial disambiguation means that ambiguity of something is reduced (i.e., the number of choices is reduced), but not completely resolved to a single choice. In this description, we will consider partial disambiguation being implemented by having choices that represent sets of lower-level choices.

Actual nodes, actual relations, or actual semantic representations refer to the kinds of objects or representations typically used for semantic representation in the system for disambiguated data (preferably a representation compatible with the knowledge base). Commonly used actual semantic representations include semantic networks and logical formulas. Disambiguating something into an actual node or relation may involve, in addition to the disambiguation, conversion to the actual representation (e.g., data types or structures) used for the knowledge base or constructing new knowledge representation components (such as nodes and links, or predicates) that are compatible with the knowledge base. Not all embodiments necessarily have a knowledge base, however.

Natural language expression means a word, utterance, sentence, paragraph, document, or other natural language input or part thereof. A constituent means a part of the natural language expression, usually parsed into an internal representation (such as a parse tree or a semantic representation), as determined by the grammar (sometimes each grammar rule is considered a constituent, but this is not always the case; the intention is not to restrict to strictly linguistic or strictly grammar-oriented interpretation). Examples of constituents include words, noun phrases, verb phrases, clauses, sentences, etc.

Some constituents may be created or inserted by the parser without having a realization in the natural language expression (in linguistics such constituents are sometimes said to be elliptic, or realized as zeroes). Examples of the uses of zero-realized constituents include handling ellipsis and representing relations that are implied by the syntax but that have no characters to represent them (e.g., the relation for the subject of a clause in many languages). In many embodiments, a non-disambiguated node is created for representing a constituent in a non-disambiguated semantic representation, but a non-disambiguated relation may also be generated for some constituents.

In this specification, simultaneously means roughly “together”, potentially affecting each other, such that the result is not necessarily the sum of the individual operations. It is not intended to mean that the operations would need to happen in parallel (as in parallel computing), though they could.

The referent of a constituent means the object or entity in the knowledge base (or elsewhere in the computer's accessible memory) that is the thing that the speaker/writer wanted to refer to.

A natural language expression is usually used in the context of a discourse (a document being considered a special kind of discourse). A discourse typically has a number of participants (such as the speaker(s) and hearer(s) (audience), or a number of interactive participants, or a writer (author) and a reader. Discourse context is also a technical term herein referring to a data structure used for tracking information about the current discourse and the context of the natural language expression therein. The discourse context also tracks which objects have been previously mentioned in the discourse and may comprise information about who are the participants of the discourse, what has already been said, what is known about the participants, what are their opinions and beliefs, etc. In some embodiments the discourse context may be part of the knowledge base.

A parse is a technical term for an alternative interpretation of a natural language expression. It refers to a way in which the parser can interpret the expression according to the grammar, and may include an interpretation of the meaning of the expression. In some embodiments, a parse includes the interpretation from the beginning of the input to the current position, whereas in some other embodiments it refers to the interpretation from some intermediate position to the current position. Parses are represented by data structures called parse contexts in the preferred embodiment. Discourse context refers to a data structure that holds information about an ongoing discourse, such as interaction with the user or reading the document. A discourse context may comprise information about many natural language expressions used by a number of parties to the discourse. It may also track quoted speech, e.g., using nested discourse contexts.

A weight means a value used to measure the goodness of an alternative. Such weights are sometimes also called scores. In some embodiments, the weights may be probabilities, likelihoods, or logarithms of likelihoods. In some others, they may represent possibility. They may also be fuzzy values, values in a partially ordered lattice, or any other suitable values for measuring the relative goodness of alternative parses or interpretations of a natural language input. While the specification has been written as higher weights meaning more likely parses, naturally the polarity could be reversed. In some systems it may be desirable to restrict weights to the range [0,1] or [−1,1]. The best weight means the weight indicating the parse or selection that is most likely to be the correct interpretation; in the preferred embodiment, it is the highest weight. “A priori weight” is used to refer to the weight “W” of choices (503,504) or combinations (505) before applying the semantic evaluator (120) to them. “A posteriori weight” is used to refer to the weight “W*” of the combinations (506) after applying the semantic evaluator to them.

A computer means any general or special purpose computer, workstation, server, laptop, handheld device, smartphone, wearable computer, embedded computer, a system of computers (e.g., a computer cluster, possibly comprising many racks of computing nodes), distributed computer, computerized control system, processor, or any apparatus whose primary function is data processing.

Computer-readable media include, e.g., computer-readable magnetic data storage media (e.g., floppies, disk drives, and tapes), computer-readable optical data storage media (e.g., optical disks), semiconductor memories (e.g., flash memory), media accessible through an I/O interface in a computer, media accessible through a network interface in a computer, networked file servers from which at least some of the content can be accessed by another computer, or any other tangible media normally used for data and program code storage by a computer.

In conventional disambiguation, each word is disambiguated separately from other disambiguation decisions. Context, including co-occurrence statistics, may be used to aid in the decision, but the statistics are normally based on the non-disambiguated words, rather than the disambiguated choices. Each node (e.g., word) or relation is disambiguated independently of other words or relations. Basically, a weight is computed for each choice for the word or relation being disambiguated, and the one(s) with the highest weight are selected.

### Device/Computer Embodiment(s)

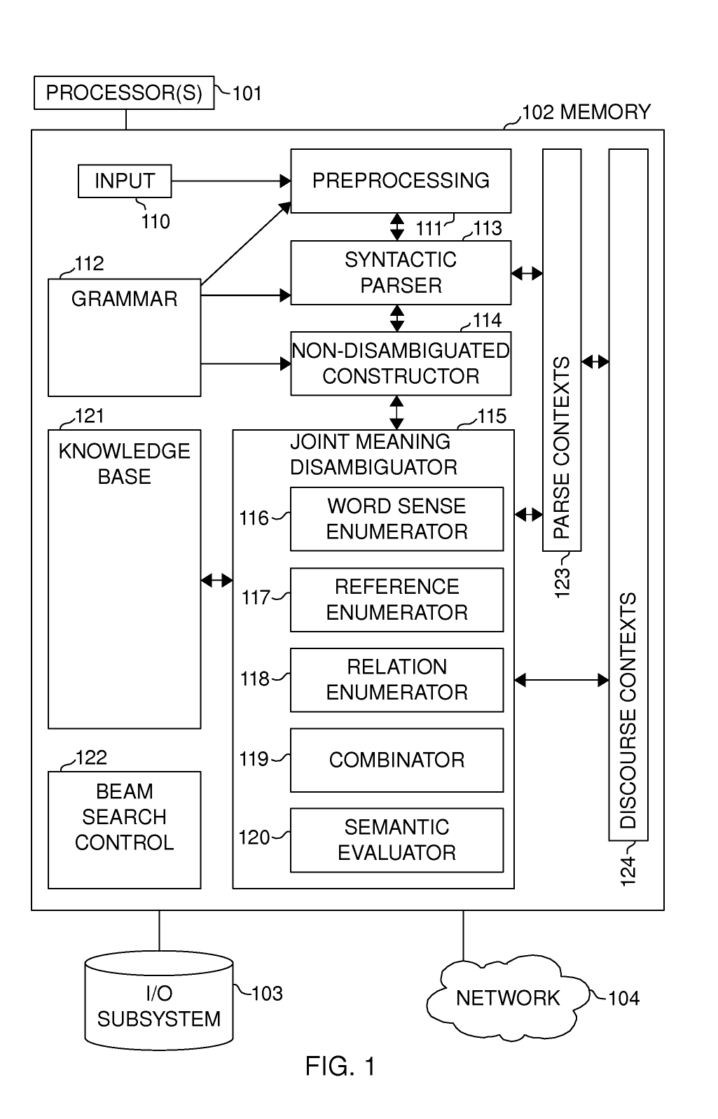

FIG. 1 illustrates an apparatus (a computer) according to a possible embodiment of the invention. (101) illustrates one or more processors. The processors may be general purpose processors, or they may be, e.g., special purpose chips or ASICs. Several of the other components may be integrated into the processor. (102) illustrates the main memory of the computer. (103) illustrates an I/O subsystem, typically comprising mass storage (such as magnetic, optical, or semiconductor disks, tapes or other storage systems, RAID subsystems, etc.; it frequently also comprises a display, keyboard, speaker, microphone, camera, manipulators, and/or other I/O devices). (104) illustrates a network interface; the network may be, e.g., a local area network, wide area network (such as the Internet), digital wireless network, or a cluster interconnect or backplane joining processor boards and racks within a clustered or multi-blade computer. The I/O subsystem and network interface may share the same physical bus or interface to interact with the processor(s) and memory, or may have one or more independent physical interfaces. Additional memory may be located behind and accessible through such interfaces, such as memory stored in various kinds of networked storage (e.g., USB tokens, iSCSI, NAS, file servers, web servers) or on other nodes in a distributed non-shared-memory computer.

An apparatus according to various embodiments of the invention may also comprise, e.g., a power supply (which may be, e.g., switching power supply, battery, fuel cell, photovoltaic cell, generator, or any other known power supply), circuit boards, cabling, electromechanical parts, casings, support structures, feet, wheels, rollers, or mounting brackets.

(110) illustrates an input to be processed using a natural language processing system. The original input may be a string, a text document, a scanned document image, digitized voice, or some other form of natural language input to the parser. More than one natural language expression may be present in the input, and several inputs may be obtained and processed using the same discourse context.

The input passes through preprocessing (111), which may perform OCR (optical character recognition), speech recognition, tokenization, morphological analysis (e.g., as described in K. Koskenniemi: Two-Level Morphology: A General Computational Model for Word-Form Recognition and Production, Publications of the Department of General Linguistics, No. 11, University of Helsinki, 1983), morpheme graph or word graph construction, etc., as required by a particular embodiment. It may also perform unknown token handling. The grammar may configure the preprocessor (e.g., by morphological rules and morpheme inventory).

Especially in embodiments performing voice recognition or OCR, at least parts of the preprocessing may be advantageously implemented in hardware (possibly integrated into the processors (101)), as described in, e.g., G. Pirani (ed.): Advanced Algorithms and Architectures for Speech Understanding, Springer-Verlag, 1990 and E. Montseny and J. Frau (eds.): Computer Vision: Specialized Processors for Real-Time Image Analysis, Springer-Verlag, 1994. Generally the input may encode any natural language expression (though not all possible expressions are necessarily supported by the grammar and other components).

The grammar (112) is preferably a unification-based extended context-free grammar (see, e.g., T. Briscoe and J. Carroll: Generalized Probabilistic LR Parsing of Natural Language (Corpora) with Unification-Based Grammars, Computational Linguistics, 19(1):25-59, 1993), though other grammar formalisms can also be used. In some embodiments the original grammar may not be present on the computer, but instead data compiled from the grammar, such as a push-down automaton and/or unification actions, may be used in its place. In some embodiments the grammar may be at least partially automatically learned. The grammar preferably comprises actions for controlling when to instantiate a non-disambiguated representation into an actual disambiguated representation. It may, for example, cause the instantiation to be performed after parsing each noun phrase or clause.

Non-disambiguated relation types are preferably declared in the grammar or in the knowledge base. Each non-disambiguated relation may correspond to one or more actual semantic network relation types or predicates, each with a different weight. Constraints may also be associated with each of the non-disambiguated relations and/or its alternative realizations. An example of such declaration is below:

relation R_SUBJ arg_of_head TH_AGT TH_EXP TH_SCAR;

This declaration specifies that for the non-disambiguated relation R_SUBJ, the value at the second argument of the relation is interpreted as an argument (e.g., thematic role) of the first argument of the relation (for this relation, the first argument is typically an instance of a verb, and the second argument is typically a noun phrase). In the actual semantic representation, this non-disambiguated relation may be realized as TH_AGT, TH_EXP, or TH_SCAR (which are relation types in the semantic representation). The order in which the actual relations are listed implies a preference order for them, and will preferably be reflected in the weight assigned to the alternatives. The weight for each alternative could also be specified in grammar rules or learned automatically.

(113) illustrates a parser capable of parsing according to the formalism used for the grammar. In the preferred embodiment, it is an extended generalized LR parser (see, e.g., M. Tomita: Efficient Parsing for Natural Language: A Fast Algorithm for Practical Systems, Kluwer, 1986) with unification. The parser may produce parse trees (or a graph-structured parse forest), unification feature structures, or other output, from which a non-disambiguated representation can be constructed, or it may directly produce one or more non-disambiguated representations, using either hand-coded rules or (semi-)automatically learned rules (similar to, e.g., Zettlemoyer et al (2009) or L. Tang and R. Mooney: Using Multiple Clause Constructors in Inductive Logic Programming, ECML 2001, Lecture Notes in Computer Science 2167, Springer, 2001, pp. 466-477).

(114) illustrates a non-disambiguated representation constructor. It constructs a non-disambiguated semantic representation of the input (e.g., phrase, clause, or sentence). The constructor is preferably integrated into the syntactic parser, for example, into parser actions triggered by the parser (such as certain reduce actions in a shift-reduce parser, or node construction in a CYK parser). In embodiments that construct a non-disambiguated representation incrementally, the non-disambiguated network (or parts of it or references to it) may be stored in parse stack nodes in a GLR parser, or parsing table nodes in a CYK parser (and analogously for other kinds of parsers).

Construction of the non-disambiguated representation may be manually coded in the grammar. The grammar may, for example, comprise actions to add a (non-disambiguated) relation between two parsed constituents, cause two grammatical constituents to be merged to the same non-disambiguated node (or unified in some embodiments), and specify what is to be considered the value of a parsed constituent (e.g., a word therein, or its semantic value, or an added relation). Actions may also specify constraints on the values and/or enforce long-distance constraints (e.g., using unification). Such actions may, for example, be encoded in the grammar as follows:

ADD R_SUBJ $1 $3;

The argument expressions may refer to constituents of a rule using, e.g., $1, $2, etc., similarly to the way they can be referenced in Yacc or Bison. As is known in the art, such references can be compiled into stack accesses (assuming GLR parser) similar to ‘stack[current_pos-regnum+1]’, where ‘current_pos’ refers to the position of the action in the rule (length of the rule if at reduce), ‘regnum’ is the number of the referenced constituent starting from the left (the first being numbered 1, etc). The relation to use in each case may be hard-coded in the grammar, or may be obtained from the knowledge base. For example, preposition words may have an associated semantic value (e.g., field or attribute) that specifies a non-disambiguated relation type to use for the preposition.

Non-disambiguated nodes may be represented by temporary identifiers (such as variables). A special relation may be used to link a non-disambiguated node to the semantic value of the word from which it was created, or such value may be stored in a field of the node. Alternatively, new semantic network nodes may be created for the non-disambiguated nodes, and these nodes may be made to refer to nodes of a semantic network in the knowledge base. The referent of a non-disambiguated node may then be replaced by actual nodes after disambiguation and reference resolution, or may be modified to point to the disambiguated (more specific) value.

Generally disambiguated nodes may refer to objects of various epistemic types, such as individuals, sets, substances, and classes. While sometimes the epistemic type of a non-disambiguated node may already be known in the non-disambiguated representation, generally it will only be determined in the joint disambiguation and actual representation construction phase. The epistemic type may be set by an enumerator or by semantic constraints.

Sometimes it may not be possible to fully disambiguate a relation or a node (for example, sometimes neither the sentence nor the context provides enough information to fully disambiguate a goal between purpose, locative goal, or, e.g., beneficiary). In such cases, implementing non-disambiguated relations as more general relations (preferably in a lattice of relations in the knowledge base) enables specializing them to the extent warranted by the available information.

Not all words from the input are necessarily included in the semantic representation. For example, conjunctions and other words with little semantic content might not be present in the representation, even though they affect the choice of relations. Also, unparseable parts might be skipped by the parser.

An example of a context-free grammar rule comprising actions for constructing a non-disambiguated representation is given below. In this example, “subj” is a non-terminal symbol for a clause subject (e.g., a noun phrase). “/R_SUBJ” causes a non-disambiguated R_SUBJ relation to be created, with the value (non-disambiguated node) returned by parsing “subj” as its second argument, and the rule head (constituent marked by “&”) as its first argument. “cvp_act” matches the auxiliaries and main verb (possibly a clitic). “residue” matches the words coming after the main verb. “/@” signals that the value of “residue” is to be merged with the rule head, causing any relations referring to it (e.g., R_OBJ) to actually refer to the rule head (cvp_act) using their first argument.

svo_act::=subj/R_SUBJ&cvp_act residue/@;

The constructed non-disambiguated representation may be stored in the parse context. In the simplest case, it may just be a list of relations or formulas in the parse context. A semantic network and other representations may also be used.

The non-disambiguated representation constructor may associate additional information with non-disambiguated nodes. Such information may, for example, indicate possible determiner interpretations (e.g., reference to prior instance, reference to shared knowledge with discourse participant, reference to generally known entity, reference to a class of objects, reference to a group of people characterized by an attribute, new group of objects with a restricting prepositional or relative clause, previously unmentioned individual). The possible determiner interpretations may be encoded in the lexicon for determiners, or may be encoded in the relevant grammatical rules. The verb being used may also influence how determiners are interpreted.

In practice, nodes usually represent nouns (or noun phrases), verbs (or verb phrases), adjectives, adverbials, etc., whereas relations typically represent prepositions, dependencies, and argument relations. However, this is not a strict rule, and the grammar, parser, lexicon, and non-disambiguated representation constructor determine how each linguistic construction is to be represented in the non-disambiguated representation.

The non-disambiguated and actual semantic representations illustrated herein using nodes and relations map nicely to semantic networks. However, semantic networks are mostly considered in the literature to be equivalent to logical formulas in expressive power, and logical formulas could equally be used. The relations (links) of a semantic network may be viewed as predicates in a set of formulas (usually implicitly conjunctively connected). The nodes may be viewed as constants, variables, or terms in logic. It is not the intention to restrict the type of semantic representations used.

Together, syntactic parsing and non-disambiguated representation construction form the first phase of constructing the semantic network (210). The second phase (211) comprises disambiguating the non-disambiguated representation and constructing one or more actual semantic representations from it. The phases alternate and may be nested or repeated.

Disambiguation is performed by the joint meaning disambiguator (115), which comprises various subcomponents, including a word sense enumerator (116), a reference enumerator (117), a relation enumerator (118), a combinator (119), and a semantic evaluator (120) for updating the weight of each parse. Some embodiments may have other enumerators or several instances of each broad type of enumerator (e.g., separate enumerators for references to discourse and for references to generally known entities).

The joint meaning disambiguator may limit the number of alternatives it produces, preferably by dropping or not creating combinations with lower weights. In practice the various components of the joint meaning disambiguator may be implemented together.

The knowledge base (121) provides background knowledge for the joint meaning disambiguator (and particularly reference enumerator(s)) and in some embodiments, also to the parser. It may comprise a lexicon, word meaning descriptions, selectional restriction information, thematic role information, grammar, statistical information (e.g., on co-occurrences), common sense knowledge (such as information about the typical sequences of events in particular situations), etc. Some disambiguation or reference resolution actions may perform logical inference over knowledge in the knowledge base. In some embodiments the knowledge base may reside partially in non-volatile storage (e.g., magnetic disk) or on other nodes in a distributed system. Data may be represented in the knowledge base using any combination of different knowledge representation mechanisms, including but not limited to semantic networks, logical formulas, frames, text, images, spectral and temporal patterns, etc.

Semantic information in the knowledge base is advantageously used in joint meaning disambiguation. Advantageous organizations of information in the knowledge base can be found from the books Helbig (2006), Brachman et al (2004), and G. Fauconnier: Mental Spaces: Aspects of Meaning Construction in Natural Language, Cambridge University Press, 1994. Such information is best utilized using inference methods such as those described in the book by Brachman. For example, Prolog-based inference could be interfaced into the parser by initiating the inference for a suitable goal (e.g., “referent(word, counterparty, WEIGHT, X, [ ])”, where “word” would be a constant representing a word for which referents are searched, “counterparty” would be a constant representing the other party to the discourse, and “X” is a variable to which a possible referent is bound and “WEIGHT” the variable to which its weight is bound. The backtracking facilities of the underlying Prolog implementation would be used to return the next potential referent for each call. If desired, additional “constraints” argument could be added, which could be a data structure describing constraints for the referent (from, e.g., adjectives and restrictive postmodifiers). The “referent” goal could be implemented in Prolog as something like:

referent(WORD, COUNTERPARTY, WEIGHT, X, VISITED):—
discourse_referent(WORD, WEIGHT, X);
shared_referent(WORD, COUNTERPARTY, WEIGHT, X);
global_referent(WORD, WEIGHT, X);
associative_referent(WORD, COUNTERPARTY, WEIGHT2, X, [WORD|VISITED]),
WEIGHT is 0.5*WEIGHT2.

associative_referent(WORD, COUNTERPARTY, WEIGHT, X):—
associated(WORD, RELATED_WORD),
not(member(RELATED_WORD, VISITED)),
referent(RELATED_WORD, COUNTERPARTY, WEIGHT, X, VISITED).

The “discourse_referent”, “shared_referent”, and “global_referent” predicates could be managed using code elsewhere. For example, “asserta(discourse_referent(WORD, WEIGHT, SEMANTIC_VALUE))” could be used to add the word currently bound to WORD to the Prolog database with weight in the variable WEIGHT and semantic value in the variable SEMANTIC_VALUE. To have the more recently referenced constituents have higher weights, one could increase the weight every time a new candidate referent is added to the database, and divide the returned weights by the weight of the most recently added one. One could also add a DC argument to each of the mentioned predicates to allow the use of multiple discourse contexts.

In some embodiments of the present invention, joint meaning disambiguation uses deep semantic information stored in the knowledge base. Deep semantic information means understanding how objects typically interact, how actions are actually performed and what steps performing them requires, what preconditions typical actions have, what typically causes what, what is the typical temporal progression of events in various situations, what kinds of goals agents typically have and how they typically try to achieve them, etc., as opposed to shallow semantic information, such as co-occurrence statistics, simplified selectional restrictions, or an ontology of concepts (such as the WordNet ontology).

The typical sequence of objects is often a powerful way of disambiguating the meaning of later actions. Very frequently, natural language texts only mention later actions very sketchily or use metaphor that is difficult to understand without understanding what is likely to happen in a particular situation. The typical sequence of events may be represented in a knowledge base in a number of ways, such as using scripts or plans (see R. Shank et al: Scripts, Plans, Goals and Understanding: An Inquiry into Human Knowledge Structures, Lawrence Erlbaum, 1977) or using relations in a semantic network. The sequence of events can be utilized advantageously using, e.g., spreading activation methods in semantic networks, or inference methods such as those described in Brachman's book.

The knowledge base preferably comprises information about the intellectual and physical capabilities of agents and objects. For example, a medical doctor is likely capable of understanding and use highly sophisticated medical terminology, whereas a layman would never use most of the medical terms and would not understand them. Given that a large knowledge processing system may know millions of highly technical concepts and terms, ambiguity can sometimes be significantly reduced by eliminating or reducing the weight of choices that the speaker/writer is unlikely to ever use.

Information about intellectual capabilities is also important for reasoning about agents and objects. Many verbs, for instance, require a subject that has certain cognitive capabilities. Information about such capabilities may be utilized during semantic evaluation of combinations by, e.g., inference methods (see Brachman's book).

The information about what the other party (or parties) in a discourse knows is also very important. It is particularly important when generating language, but it can also be used in understanding, for example, to reduce the weight of combinations that are outside the other party's field of expertise. In some embodiments the surprise of the other party knowing something may also be an important component of the meaning of the natural language expression, to be represented separately in its own right. It may, for instance, signal incorrect assumptions about the secrecy of some information in the knowledge base, and may be used to trigger actions, such as reporting a potential security breach.

The semantic representation for natural language constructs that reference previously mentioned or previously known entities advantageously comprises references to the knowledge base. Such references are advantageously represented using pointers. A pointer should be interpreted to mean any reference to an object, such as a memory address, an index into an array, a key into a (possibly weak) hash table containing objects, a global unique identifier, or some other object identifier that can be used to retrieve and/or gain access to the referenced object. In some embodiments pointers may also refer to fields of a larger object.

The meaning representation for actions is advantageously represented by a pointer to a generalized action description in the knowledge base, plus information about arguments for a particular instance of the action.

The beam search control (122) controls the overall search process and manages the parse contexts (123). Beam search typically means best-first search, with the number of alternatives limited at each step (or, to within a threshold of the best alternative). Beam search is described in, e.g., B. Lowerre: The Harpy Speech Recognition System, Ph.D. thesis, Carnegie Mellon University, 1976 (NTIS ADA035146).

The parse contexts (123) represent alternative parses. Typically there will be a number of alternative parse contexts for each input at each step of parsing. Parse contexts may comprise, besides parser-related data such as a parse stack, semantic information such as the non-disambiguated semantic representation and/or actual semantic representations (or fragments thereof). Parse contexts may be merged in some embodiments (e.g., when implementing graph-structured stacks, in which case semantic content may be joined with an “OR” (disjunction) operator). In chart parsers, parse contexts may correspond to nodes in the chart or table (each table slot possibly containing a list of alternative parses or nodes).

The discourse contexts (124) comprise information about the current discourse and previously parsed sentences (though some embodiments may keep several sentences in the parse context). The discourse context and parse context may both influence the disambiguation. For example, individuals, concepts and topic areas that have already been discussed in the same conversation or document are much more likely referents for later expressions in the same document.

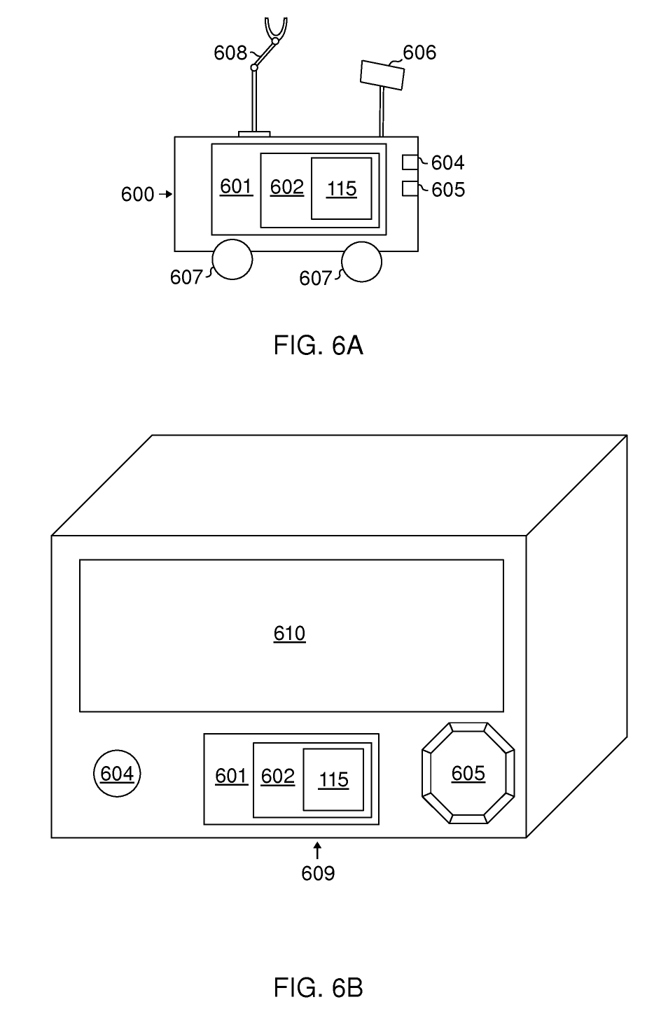

FIG. 6A illustrates a robot according to an embodiment of the invention. The robot (600) comprises a computer (601) for controlling the operation of the robot. The computer comprises a natural language interface module (602), which comprises a joint meaning disambiguator (115). The natural language module is coupled to a microphone (604) and to a speaker (605) for communicating with a user. The robot also comprises a camera (606) coupled to the computer, and the computer is configured to analyze images from the camera at real time. The image processing module in the computer is configured to recognize certain gestures, such as a user pointing at an object (see, e.g., RATFG-RTS'01 (IEEE ICCV Workshop on Recognition, Analysis, and Tracking of Faces and Gestures in Real-Time Systems), IEEE, 2001 for information on how to analyze such gestures). Such gestures provide extralingual information that may be used in disambiguating the referent of certain natural language expressions (e.g., “take that bottle”). The robot also comprises a movement means, such as wheels (607) with associated motors and drives or legs, and a manipulator (608) for picking up and moving objects. The voice control interface makes the robot much easier for people to interact with, and joint meaning disambiguation according to the present invention enables the voice control interface to understand a broader range of natural language expressions, providing improved user experience.

FIG. 6B illustrates a home or office appliance according to an embodiment of the invention. The appliance (609) comprises a computer (601) with a natural language interface (602) and a joint meaning disambiguator (115), as described herein. It also comprises a microphone (604) and speaker (605), and a display device (610) such as an LCD for displaying information to the user. As a home appliance, the appliance may be, e.g., a home entertainment system (typically also comprising a TV receiver and/or recorder, video player (e.g., DVD or Blu-Ray player), music player (e.g., CD or MP3 player), and an amplifier) or a game console (typically also comprising a high-performance graphics engine, virtual reality gear, controllers, camera, etc.), as they are known in the art. As an office appliance, it may, for example, provide information retrieval services, speech-to-text services, video conferencing or video telephony services, automated question answering services, access to accounting and other business control information, etc., comprising the additional components typically required for such functions, as are they known in the art. An improved natural language understanding capability due to the present invention could enable less skilled users to utilize the devices. This could be commercially important especially in countries where many high-level managers are not comfortable working with computers and/or typing.

The appliance may also be a mobile appliance (including also portable, handheld, and wearable appliances). Such appliances fundamentally differ primarily in miniaturization and in other components known in the art. In such an appliance, significant parts of the voice control interface, including the joint meaning disambiguator, would preferably be implemented in digital logic to reduce power consumption, but could also be implemented in software. The present implementation may, for example, enable the construction of better portable translators than prior solutions.

Each kind of appliance would also comprise other components typically included in such appliances, as taught in US patents.

### Method Embodiment(s) for Constructing Semantic Representation

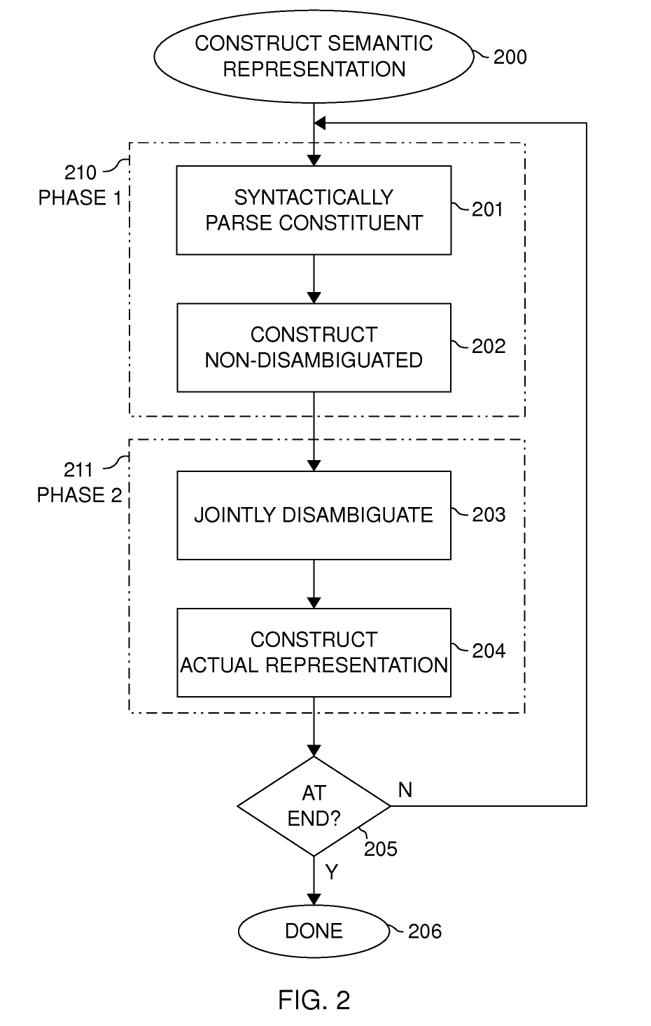

FIG. 2 illustrates construction of a semantic representation of a natural language input according to an embodiment of the invention. (200) indicates the beginning of the process. (201) illustrates syntactically parsing at least one constituent (which may or may not have subconstituents). (202) illustrates constructing the non-disambiguated representation. It may be created during parsing as described above, or it may be constructed from a parse tree or dependency tree after parsing, e.g., a full sentence or paragraph.

(203) illustrates joint disambiguation (possibly including reference resolution). The basic idea is to simultaneously select, for each ambiguous element of the non-disambiguated representation, the choice that results in the best overall weight for the entire disambiguated representation. More than one disambiguated representation with a high weight may be retained, and parse contexts may be created for each such alternative disambiguated representation. In some embodiments the selection may be approximate for performance reasons. Some of the ambiguous aspects of the semantic representation may also relate to the layout of a semantic network to be generated as the actual representation. For example, the lexicon entries for word senses could contain a model of the network to be constructed for the natural language construct involving the word sense. In some other embodiments, disambiguation might select one or more of the arguments for a logical predicate.

The final disambiguated semantic representation is constructed in (204). For a semantic network, nodes of the semantic network are created (if not already created during disambiguation) and made to refer to the disambiguated choices, and links are created based on disambiguated choices for relations. For a logic-based representation, constants are created (or taken from the disambiguated choices) for the nodes, and predicates are created for the disambiguated choices for relations, as well as for any class memberships or other attributes for nodes. The normal API for the semantic network or logic-based knowledge representation system would typically be used for creating the nodes and links/relations (or terms or predicates in logic-based systems).

At (205), unless the entire input has already been processed, the process continues from (201). This step primarily just illustrates that the process can be repeated arbitrarily many times. The repetition may be either nested (processing smaller and larger parts of the same natural language expression) or iterated (e.g., first processing one sentence, then another). In the preferred embodiment nesting is performed under the control of the grammar, using a special action associated with the reduction of certain rules to trigger disambiguation. Reaching the end of the input (or having constructed the semantic representation for a top-level linguistic entity, such as a message) is illustrated by (206).

The disambiguated representation may be constructed in the knowledge base. However, in some embodiments it may also be kept separate, for example, in a discourse context or the parse context, and later merged with the main knowledge base. The representation may also be, e.g., saved in a file or database in non-volatile storage or communicated to another computer over the network.

Some non-disambiguated nodes may be realized as nodes representing variables or quantified nodes in the actual representation, as described in the books by Helbig and Sowa.

### Joint Disambiguation in Detail

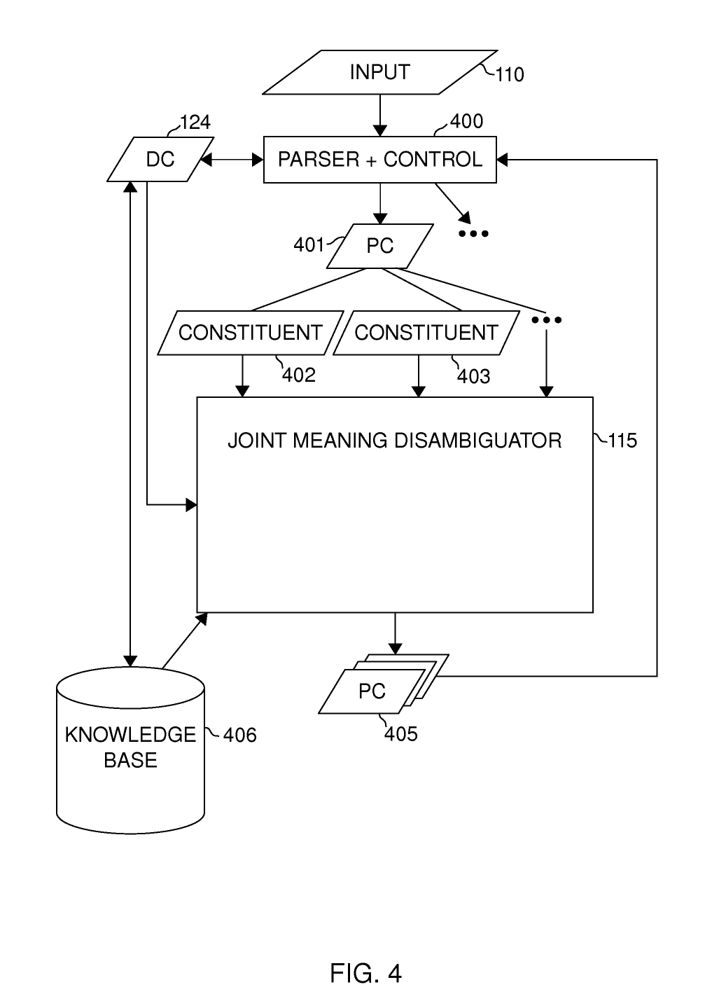

FIG. 4 illustrates how joint disambiguation can be embodied in a natural language processing system. The embodiment is shown in the context of one discourse context (124); an actual embodiment would typically have a plurality of discourse contexts, each with its associated parse contexts. In many embodiments different discourse contexts could be used in parallel, using multiple threads and/or multiple processors. (110) illustrates the input, (400) the syntactic parser and control logic for controlling parsing and triggering joint disambiguation at certain points during parsing (roughly, (113)+(114)), (401) illustrates a parse context for which joint disambiguation is to be performed. The constituents (402) and (403) illustrate constituents from the input as interpreted in the parse context (401). There could be more than two of them. In at least some calls to the joint meaning disambiguator, at least two of the constituents are ambiguous (i.e., have more than one possible choice; if only one constituent is ambiguous, then there is no need to use joint disambiguation and conventional disambiguation could be used equally well).

The joint disambiguation (115) produces a number (zero or more) of new parse contexts (405). Conceptually these parse contexts replace the original parse context (401). In an implementation, it is possible that one of the new parse contexts is the same data structure as (401); however, they could also all be new data structures. If no parse contexts are produced, then it means that the parse in (401) did not make semantic sense; if more than one parse context was produced, then the disambiguation was not unique, but the weights indicate which is the best parse. Further parsing of the input may adjust the weights and trigger further (joint) disambiguations, which may eventually raise one of the parse contexts with less than best weight to have the best weight (or even be the only remaining parse context).

Joint disambiguation preferably uses the knowledge base (406), particularly when evaluating the different combinations and when determining what weight to assign to each choice.

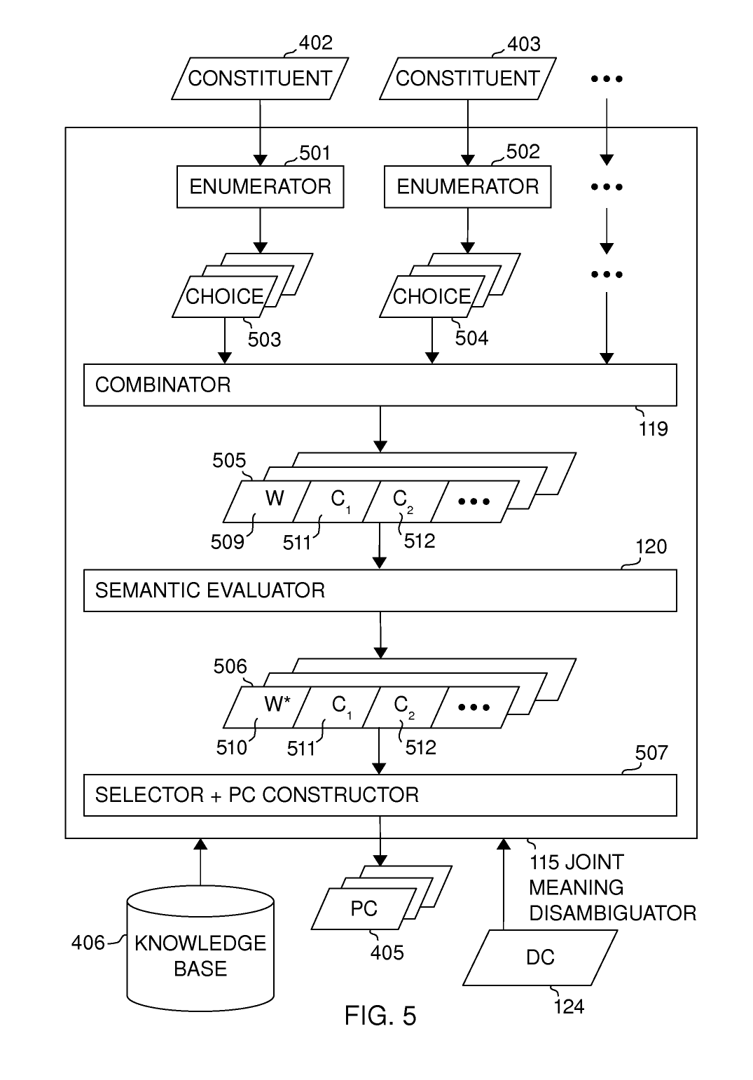

FIG. 5 illustrates data flow within a preferred embodiment of a joint meaning disambiguator. At least two ambiguous constituents (402,403) are obtained from a parse context. Enumerators (501,502) are used to enumerate choices for each constituent. There may be several kinds of enumerators, such as a word sense enumerator (116), a reference enumerator (117), and a relation enumerator (118). The enumerators preferably first return the choice with the best weight, then the second best, etc.

The enumerator to use for each constituent may be specified, e.g., by the grammar rules that interpreted the constituent or by the lexicon. It may also be selected based on attributes of the constituent (or non-disambiguated node/relation), particularly based on its determiner, if any. For example, if the determiner is interpreted as referring to a new instance, the word sense enumerator might be used. If the determiner is interpreted as referring to a previously mentioned entity or a generally known entity, then the reference enumerator might be used. For relations, the relation enumerator would preferably be used. Sometimes the enumerators may be combined (for example, the reference enumerator might enumerate references for all senses of the constituent), or several enumerators may be used for the same constituent.

The reference enumerator may use a list of recently referenced entities (stored in the parse context (401) or discourse context (124) and preferably maintained by the parser (400) or the disambiguator (115)). It may weigh the choices based on how recent the use was, various saliency or accessibility criteria known in the art (see, e.g., T. Fretheim et al: Reference and Referent Accessibility, John Benjamins Publishing Company, 1996), and/or how well the constituent being considered matches restrictions and constraints of the referring constituent (e.g., class, gender, restrictive adjectives, prepositional clauses, restrictive relative clauses, type of activity, determiner interpretation, proximity, extralingual references (e.g., pointing to an object, direction, or area as determined using vision, or identified by sound) extracted from other sensor modalities). It may continue to enumerate matching objects in shared knowledge and general knowledge. In principle there is no limit on how many references it may enumerate. Preferably they are enumerated in decreasing order of weight, and the joint meaning disambiguator will stop obtaining more references when the weight has become sufficiently small or a resource limit (e.g., a time limit) of some kind has been exceeded.

One method for the reference enumerator is to enumerate the choices in order of decreasing saliency. Generally, saliency for items in the current discourse decreases with time. The enumerator may enumerate all items previously mentioned in the current discourse, the most recently mentioned first. Each item would be matched against constraints from the referring constituent (e.g., adjectives, relative clauses, etc). In a simple implementation, direct matching of adjectives can be used (if the referring adjective is present, the candidate is accepted, otherwise not; relative clauses could be ignored in a simple implementation). The weight of the candidate could be computed from the distance, the most recently mentioned entity given weight 1.0, and the weight for any other entity decreased by a constant factor (e.g., 0.7) for each subsequent candidate. How to implement a reference enumerator is known in the art, and is described in D. Cristea et al (1999), where it is called the COLLECT module (and its FILTER and PREFERENCE stages are analogous to the semantic evaluator; however, it describes nothing corresponding to the combinator (119) and its FILTER and PREFERENCE operations do not operate on combinations of choices).

A more detailed description of enumerating referents can be found in S. Lappin et al: An algorithm for pronominal anaphora resolution, Computational Linguistics, 20(4):535-561, 1994 and M. Kameyama: Recognizing referential links: An information extraction perspective, pp. 46-53 in Proc. ACL/EACL'97 Workshop on Operational Factors in Practical, Robust Anaphora Resolution, Association for Computational Linguistics (ACL), 1997.

The enumerators, particularly the reference enumerator, may perform link traversals in the knowledge base, e.g., to find more general or more specific concepts or to find associated concepts, and may also perform inference (preferably using an inference engine configured to terminate quickly with some result, even if the result is “don't know”). Any known inference method may be used, such as spreading activation, resolution, goal-oriented reasoning, forward chaining, or backward chaining. The book by Brachman et al (2004) describes a number of inference methods.

Pronouns, definite noun phrases and proper names are just some of the constituent types for which the reference enumerator may be used. For example, verbs, particularly gerunds and infinitives and sometimes also finite verbs (e.g., “I did so too”), can be referring.

The word sense enumerator preferably enumerates all word senses for the constituent (preferably, for the word that is the head of the constituent or the only word therein).

The word sense enumerator may also return senses that have been defined in the conversation or document itself. It may also be sensitive to prior discussions with the same party, the technical field of a document being read, including technical or jargon senses only when processing a document of that field (or adjusting their weights heavily based on whether the technical field matches). Some returned senses may have been learned from prior documents processed or conversations held.

For the relation enumerator, the choices for each constituent (or non-disambiguated relation type) are preferably configured in the grammar or the knowledge base. They may also have been automatically learned.

The weight for each choice may depend on the weight of the original parse context (401), the relative weight assigned to each choice among the choices for that constituent, and may additionally depend on other data, such as genre information in discourse context, the topic and focus of the conversation or topic of a document, and/or statistical information.

A number of choices (503, 504) are obtained for each constituent by the applicable reference enumerator(s). In rare cases the number may be zero (e.g., if no matching referent is found), causing joint disambiguation to return no parse contexts in the preferred embodiment (no choices for one constituent→no combinations). This is a situation where alternative determiner interpretations may be useful. For ambiguous constituents the number of choices is more than one.

Combinations of the choices (505) are generated by a combinator (119). If at least one constituent has multiple choices (and no constituent has zero choices), then multiple combinations will be generated. The a priori weight (509) for each combination is computed from the weights of the choices, and may also depend on other information, such as statistical information about how likely certain senses are to be used together.

Each combination comprises a choice selection (511,512) for each of the constituents (402,403). There should normally be as many choices as there are constituents. However, some embodiments may handle non-ambiguous constituents separately, and it is also possible to use other disambiguation methods for some constituents. Such constituents are not considered ambiguous aspects for joint disambiguation here.

The a posteriori weight (510) for each combination is evaluated by a semantic evaluator (120), enforcing constraints and using any available statistics and semantic information to adjust the weights. Some combinations may be outright rejected (filtered) by the semantic evaluator.

This results in a number (zero or more) of combinations with a posteriori weights (506). The desired number of best combinations are then selected and parse contexts are created for them (constructing the disambiguated representation as appropriate in each embodiment, based on the choices indicated in the combination) (507). The pc constructor need not be part of joint disambiguation in all embodiments; it could be performed outside the joint meaning disambiguator, or some embodiments might not even construct parse contexts.

Evaluation of combinations and filtering of low-weight combinations may also be done during the construction of combinations. In fact, it is preferable to filter combinations that cannot produce good results as early as possible.

To formalize a different embodiment of the joint disambiguation problem, there is a set of non-disambiguated nodes ‘N’ and a set of non-disambiguated relations ‘R’ (each non-disambiguated relation with one or more arguments).

Each non-disambiguated node has a set DETS(n) of possible determiner interpretations for the node. The determiner interpretations affect reference resolution, and may, e.g., differentiate between looking for a previously known referent (from the context, general knowledge, or concepts related to previously discussed topics) or may differentiate between restrictive and descriptive interpretation of postmodifying relational clauses (since many writers use determiners somewhat inconsistently, these selections preferably modify weights rather than absolutely determine how a constituent is to be interpreted). Determiner interpretation may also affect the choice of enumerator(s) used.

Each non-disambiguated node may be disambiguated into any of a number of values. The set of possible values into which a node ‘n’ may be disambiguated and their weights, given a determiner interpretation ‘det’, is indicated by NODES(det, n). This set may include word senses of ‘n’, specializations of ‘n’, previously parsed constituents (for referring phrases), various kinds of previously discussed objects from the discourse context, objects associated with previously mentioned objects, objects discussed with the same counterparty in earlier interactions (shared knowledge), and generally recognized objects (which may be culture-dependent). The set need not be explicitly constructed, but generally needs to be enumerable in rough salience order (represented by weight). Each value in the set is preferably associated with a weight indicating its salience.

Each non-disambiguated relation may be disambiguated into any of a number of actual relations, depending on the type of the non-disambiguated relation. The set of possible actual relation types for a non-disambiguated relation and their weights is indicated by RELS(r).

Constraints on relation arguments and semantic nodes may be modeled using functions REL_WEIGHT(reltype, [n1, n2, . . . ]) and NODE_WEIGHT(node, [r1, r2, . . . ]). (The [x1, x2, . . . ] represent lists of values x1, x2, . . . )

REL_WEIGHT determines how suitable ‘n1’, ‘n2’, etc., are as arguments for relation type ‘reltype’ (‘reltype’ is the type of a relation ‘r’), returning 0 if they are not acceptable, and 1.0 if they are maximally acceptable, and a value in between if they are somewhat acceptable. It represents, e.g., co-occurrence statistics and argument type constraints for relations.

NODE_WEIGHT determines how suitable the collection of relations ‘r1’, ‘r2’, etc. are for attaching to semantic network node ‘node’. If they are unacceptable (e.g., having more than one “Agent” relation could be forbidden), the function returns 0, and if they are maximally acceptable, it returns 1.0, and otherwise something in between. It represents, e.g., selectional restrictions, argument combination restrictions, and co-occurrence statistics.

Naturally other ways of representing the constraints and taking into account, e.g., various statistics are possible, and such constraints and statistics could be implemented as steps within the joint disambiguation process, rather than as the functions. Where a variable number of arguments to the functions is indicated, e.g., a list or an array could be used to pass the arguments.

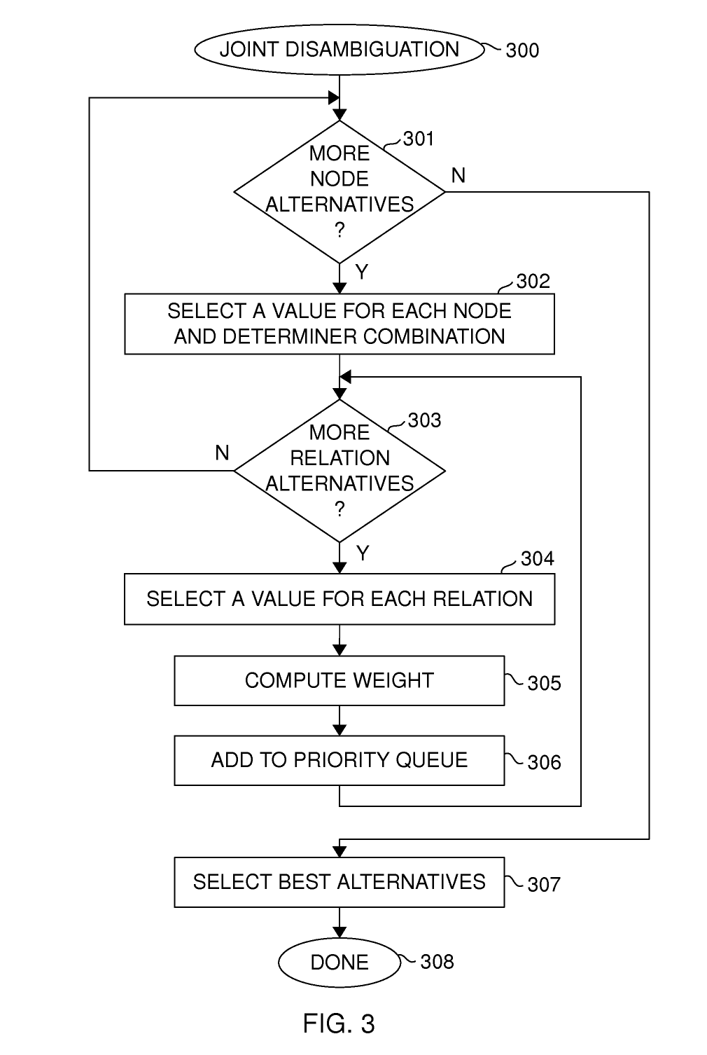

A brute-force method for joint disambiguation is illustrated by the following pseudo-code and FIG. 3. In the pseudo-code, “for (vars:list)” illustrates iteration over all elements of the list, assigning each of “vars” during each iteration; [x, y, z] indicates list construction; [x:y] indicates construction of a pair (similar to CONS in Lisp); PriorityQueue is a type for a priority queue (e.g., a heap data structure); List illustrates a generic list type; “.first” takes the first element of a list, and “.tail” returns a list with the first element removed. Empty list [ ] is treated as equivalent to FALSE. “ . . . ” illustrates that the function may take any number of arguments (which may be passed as a list). “lst[n]” is used to illustrate getting the nth element of a list. Otherwise the syntax used resembles that of the C, Java, C#, and C++ programming languages. PseudoNode is a type for a non-disambiguated node; PseudoRel for a non-disambiguated relation. Node and Rel are the corresponding types for disambiguated nodes and relations. ParseContext is a type for a parse context. The various types would usually be implemented as structures or objects in a programming language. The top-level function is ‘joint_disambiguate’; the ‘pnodes’ argument is a list of non-disambiguated nodes, ‘prels’ is a list of non-disambiguated relations, and ‘pc’ is a parse context:

PriorityQueue pq;
void rel_recurse (ParseContext pc,

List prels,
List node_choices,
List rel_choices,
double weight)

{

| | |
|---|---|
| /* | If no more relations, create a candidate disambiguated |

representation and add it to the priority queue. */

if (!prels)

{

| | |
|---|---|
| /* | Update weight based on relations selected for |

each node. */

double w = 1.0;
for (PseudoNode pn, Node n : node_choices)

{

List rels = find relations referencing ‘n’

from rel_choices;

w *= NODE_WEIGHT(n, rels);

| | } |
|---|---|
| /* | If the weight is sufficiently high (e.g., > 0, or |

within a threshold of the best so far), add
to priority queue. */

if (w > MIN_WEIGHT)

pq_add(pq, w * weight,

[pc, w * weight, rel_choices,
node_choices]);

return;

| | } |
|---|---|
| /* | Process the first non-disambiguated relation from the |

list, recursively selecting alternative realizations of
the relation. */

PseudoRel pr = prels.first;
List args = map arguments of ‘pr’ from pseudo-nodes to

actual nodes using ‘node_choices’;

for (RelType reltype, double w : RELS(pr))

{

double rw = REL_WEIGHT(reltype, args);
rel_recurse(pc, prels.tail, node_choices,

[[pr, reltype, args] :
rel_choices],
rw * weight);

}

}

| /* | Calls ‘rel_recurse’ for all combinations of disambiguated |
|---|---|
| | node values. */ |

void node_recurse(ParseContext pc,

List pnodes,
List prels,
List node_choices,
double weight)

{

/* If all nodes processed, then process relations. */
if (!nodes)

{

rel_recurse(pc, prels, node_choices, [ ], weight);
return;

| | } |
|---|---|
| /* | Process the first non-disambiguated node on the list, |

recursively selecting alternative determiners and
disambiguated values for the node. The selected node
is recorded in the ‘node_choices’ list, and weight is
updated. */

PseudoNode pn = pnodes.first;
for (DetInterp det : DETS(pn))

for (Node n, double w : NODES(det, pn))

node_recurse(pc, pnodes.tail, prels,

[[pn, n] : node_choices],
w * weight);

}
/* Top-level joint disambiguation function. */
List joint_disambiguate(List pnodes, List prels,

ParseContext pc)

{

| pq.make_empty( ); | |
|---|---|
| /* | Create alternative actual representations in priority |
| | queue. */ |
| node_recurse(pc, nodes, prels, [ ], pc.weight); | |
| /* | Get MAX best alternatives from the priority queue and |

create parse contexts for them. */

List retval;
for (i = 0; i < MAX && pq.count ( ) != 0; i++)

{

List lst = pq.get_best( );
ParseContext new_pc =

new ParseContext(lst[0] , lst[1], lst[2], lst[3]);

retval = [new_pc : retval];

}

return retval;

}

The basic idea is to enumerate all combinations of the different selections for determiner interpretations, nodes, and relations. While the time complexity of the method is exponential in the number of nodes and relations, in practice the number of nodes and relations can be kept small by crafting the grammar in such a way that it invokes the joint meaning disambiguator fairly frequently, such as at the end of each noun phrase and at the end of each clause (including relative clauses). In such way, there will be at most a few previously non-disambiguated nodes and relations in the non-disambiguated representation, and thus the disambiguation will be quite fast in practice, despite being theoretically exponential. Already disambiguated nodes and relations do not normally add to the complexity, as they have only one value in their NODES(det, n) or RELS(r) sets. The method could be adapted to handle them first or separately.

A competent Lisp programmer should be able to fill in the parts described with words in the pseudo-code without undue experimentation, as e.g., mapping values using an “assoc list” (here, ‘node_choices’ and ‘rel_choices’) and filtering (finding) values from a list are very common in Lisp programs. Clearly a hash table (or various other data structures) could also be used instead of a list. The code assumes that the discourse context is accessible through the parse context, but it could also be supplied as an explicit argument. Instead of a priority queue, any other suitable data structure and method for selecting the desired number of best alternatives could be used. The code is intended as just an example, and many other implementations are also possible.

In this example, NODES(det, n) corresponds a combined word sense and reference enumerator, and the returned weights, nodes, and relations correspond to the choices (503,504). The construction of such an enumerator was described above. REFS(r) corresponds a relation enumerator. Together they represent the enumerators (501,502). The functions node_recurse and rel_recurse correspond to the combinator (119). Here, combination is performed for non-disambiguated nodes and non-disambiguated relations separately; they represent the constituents (402,403). However, the invention does not require the use of a non-disambiguated representation separate from the constituents or any particular kind of representation.

The a priori combinations (505) are represented by the node_choices and rel_choices lists together (when they are completely constructed in the “if (!prels)” case in rel_recurse). The a posteriori combinations (506) are represented by the values added to the priority queue.

The use of a priority queue and the loop in the joint_disambiguate function after calling node_recurse corresponds to the selector+pc constructor (507).

The ‘pc’ argument corresponds to the original parse context (401) and the list of new parse contexts that is returned by the function corresponds to the new parse contexts (405).

The NODE_WEIGHT and REL_WEIGHT functions and the code that calls them corresponds to the semantic evaluator (120). In one embodiment, REL_WEIGHT returns 1 for all arguments (there are no argument type constraints on relations, or they are enforced by the parser). In another embodiment, there are strict argument constraints for relation arguments. If the arguments are acceptable according to the constraints for ‘reltype’, then REL_WEIGHT returns 1. If they are not, it returns 0. In yet another embodiment, argument type constraints are fuzzy, and REL_WEIGHT returns a value according to the degree of acceptability of the arguments (0 indicating not acceptable, 1 indicating fully acceptable, and values in between indicating degrees of marginal acceptability).

One important function of NODE_WEIGHT is to represent selectional restrictions (e.g., what kind of subject and object a particular verb sense may take, or what kind of adjectives may characterize a particular noun). While not all embodiments require selectional restrictions, most embodiments are expected to utilize them. In one embodiment, the argument ‘node’ determines the word sense being considered, and NODE_WEIGHT reads selectional restriction information from that word sense (or its associated semantic information). Selectional restrictions may specify that some relations (relation represent arguments or thematic roles) are mandatory. In such case, if a mandatory relation is not present, NODE_WEIGHT returns 0. The restrictions may specify that some relation can occur only once (with ‘node’ as the first argument); if it occurs more than once in the list of relations, then NODE_WEIGHT returns 0. The restrictions may specify that the value of an argument (relation) be of a particular kind (e.g., belong to a particular class or its subclass in an ontology); in that case, if it does not belong to the specified class, NODE_WEIGHT returns 0. The restrictions may specify that the value of an argument must be of a particular epistemic type; if it is not, then NODE_WEIGHT returns 0. Other restrictions/constraints may also be enforced in a similar manner. If all constraints are met, then NODE_WEIGHT returns 1.

In another embodiment the semantic restrictions are fuzzy, and rather than returning 0 if some restriction is not fully met, NODE_WEIGHT returns a value between 0 and 1 indicating the degree to which the restriction/constraint is met.

In yet another embodiment, there can be syntactic restrictions on arguments of a word (e.g., verb), for example, requiring the other argument of a particular relation to be a value that is a reflexive pronoun, in a particular grammatical case, or a particular kind of phrase (e.g., to-infinitive). A relation could also have a syntactic constraint requiring that it be specified by a particular preposition in the input (e.g., “for”). Further constraint types could require that two different arguments of a verb have the same referent. Such syntactic and other constraints could be handled analogously to semantic restrictions described above. Implementing such constraints may require that syntactic information from the parser is available through the constituent (or non-disambiguated element) passed to joint disambiguation.

NODE_WEIGHT can also be used for indicating preferences for the kinds of arguments that are thematic roles of actions. Actions can be expressed in the natural language expression using, e.g., verbs or nouns that indicate action, activity, process, event, or function. Deep semantic information may connect objects and actions, enabling attributes typically used for characterizing an action to be used for a noun related to the action.

NODE_WEIGHT can also be used for determining how acceptable various types of arguments are for nouns. This can be important, for example, for interpretation of compound nouns (where the first noun may mean, e.g., material, association, cause, etc).

NODE_WEIGHT can also be used in determining what adverbials can attach with what verbs. For example, some adverbials can only attach to verbs that have clear temporal duration (i.e., that are not instantaneous). Such constraints can also help in determining the scope of adverbials in a sentence.

In yet another embodiment, NODE_WEIGHT and/or REL_WEIGHT uses statistical information as part of the weight. It may, for instance, compute a score between 0 and 1 indicating how frequently the sense supplied for the relation indicating an object is used with the sense for a verb. Such a score may be multiplied with the return value of NODE_WEIGHT. Similar statistical scoring could be used for REL_WEIGHT, based on how frequently certain word senses or their classes or superclasses occur as arguments of the selected actual relation. Any known method for such statistical scoring and for combining multiple weights/scores/probabilities may be used; see, e.g., Navigli (2009).

The DETS function returns the possible determiner interpretations for the constituent. Its function is described as part of the enumerators, though it could also be viewed as a separate component, or as selecting a particular enumerator. In some embodiments there will always be only one determiner interpretation for each constituent; however, in the preferred embodiment some constituents have multiple possible determiner interpretations, each with a separate weight that is used in computing the a priori weight for the enumerated choices (503,504). Possible determiner interpretations are preferably encoded for determiners, semi-determiners, pronouns and certain other words in the lexicon or the knowledge base.

In some embodiments the semantic evaluator (120) may be spread throughout the joint meaning disambiguator. In the pseudo-code, the weight was updated in several places, with the intention of reducing the number of calls to the functions and taking information into account as early as possible (to facilitate various optimizations described below).

In some embodiments some aspects of the choices may not be fully determined by the enumerators. For example, the epistemic type of a choice might not be specified by the choice, but might be assigned by the semantic evaluator (possibly replicating the combination into many combinations where different epistemic types are used, if multiple epistemic types are possible in a particular instance).

The brute force method used in the pseudo-code can be optimized by traversing the DETS, NODES, and RELS sets starting from the value with the highest weight, combining weights by multiplication, and limiting all weights and multipliers to 1.0. This results in the weights of combinations (505) always decreasing (though the decrease is not necessarily monotonic). The best weight currently in ‘pq’ could be tracked, and if at any point the weight of the current alternative being considered yields a weight too much lower than the best weight, the current branch in the recursion can be pruned, as the weight cannot increase so it cannot become any better.

Alternatively, ‘pq’ could be limited to hold ‘max_answers’ parses, and when this value has been reached, track the weight of the lowest weight parse in the priority queue. If any weight during the recursion falls below this weight, it is known that no result from the current branch in the search can become better than the worst result already in the maximum-sized priority queue, and thus that branch of the recursion can be pruned. In practice these simple optimizations are quite effective. The order of the various enumerations should be selected to maximize the slope of the decrease of the weights (most steeply decreasing enumerated first), based on characteristics of a particular embodiment (possibly learned dynamically), to prune the combination generation as early as possible.

The method could be further augmented by using additional information and features similar to the way such information and features are used in conventional word sense disambiguation (see Navigli (2009)). Such information could be used in computing/adjusting the weights (in enumerators, in the combinator, and/or in the semantic evaluator).

FIG. 3 further illustrates a simplified method embodiment of joint disambiguation (300). The basic idea of steps (301) and (302) is to enumerate all combinations of disambiguation selections for nodes, for all determiner alternatives specified for each node. Step (301) illustrates checking if there are more combinations, and (302) getting the next combination of disambiguated nodes. In practice this would best be implemented as a recursive function, using simulated recursion with a stack, or by having, e.g., an array of indices each selecting the current disambiguated alternative for each node.

Steps (303) and (304) similarly enumerate all combinations of disambiguation selections for relations. (A different embodiment might enumerate relations first and nodes then, or might enumerate combinations of both in a single loop.)

Step (305) computes the weight of the resulting alternative. This preferably utilizes any available information for disambiguation and reference resolution.

Step (306) adds the candidate (i.e., the combination or node and relation choices) to a priority queue. Preferably some sort of filtering is used to limit the number of candidates added. The preferred approach is to enumerate the choices and combinations in roughly decreasing order of weight, and prune the generation of combinations immediately when it can be determined that the resulting weight cannot be “good enough”. Such pruning may be based on a fixed limit weight, weight relative to the current best candidate (e.g., threshold computed from its weight), the number of weights currently kept, and/or the weight of the lowest weight candidate in the priority queue. Excess candidates may be removed from the priority queue in this step, e.g., if its size is limited.

Step (307) returns the best alternatives (e.g., the N candidates with the highest weights) from the priority queue. Preferably parse contexts are created for them, and added to a second priority queue maintained by the beam search control logic (which may also drop some parse contexts to limit their number). Step (308) illustrates having completed the method.

In some embodiments, joint disambiguation may call itself recursively. For example, one could first disambiguate the subject and object of a verb using a recursive call, and then disambiguate the verb sense and the actual relations/thematic roles used for the grammatical subject and object (e.g., Agent vs. Patient vs. State Carrier vs. Instrument vs. Experiencer, etc). Dividing the non-disambiguated representation makes the disambiguation much faster, and even though it may theoretically miss some globally best alternatives, selecting locally best alternatives by jointly disambiguating only a small number of nodes or relations at a time often works well in practice. However, care is required in such embodiments; for example, if the subject is a pronoun, it may be important to disambiguate the subject and the verb jointly.

In some embodiments some nodes might be only partially (or not at all) disambiguated in the first call, and their final disambiguation might be postponed to a later call to the joint meaning disambiguator, at which time more information is available for the disambiguation. It is possible to leave some nodes not fully disambiguated even in the final network; the last call to the joint meaning disambiguator could, for example, create disjunctive expressions for such nodes or relations.

Partial disambiguation may be implemented by enumerating choices for a constituent by arranging the choices into a hierarchy (e.g., first coarse word senses, and then more fine grained word senses under them). The enumeration process might check if there is more than one acceptable (or sufficiently high weight) fine grained sense under a coarse sense, and in that case only disambiguate to the coarse sense, but otherwise disambiguate all the way to the fine grain sense. Alternatively, specializing joint disambiguation may be used to implement partial disambiguation.

Joint disambiguation can also be advantageously utilized in connection with ellipsis resolution, including both anaphoric ellipsis and cataphoric ellipsis, particularly when combined with the techniques disclosed in the co-owned U.S. patent application Ser. No. 12/613,874, which is hereby incorporated herein by reference. Elliptic constituents are constituents that are realized as zero, i.e., left out from the surface syntax (typically because they are obvious from the context). The referent of an elliptic constituent can be one of the ambiguous aspects to be resolved by joint disambiguation. A sentence could have more than one elliptic constituent, each of which could be resolved by joint disambiguation if ambiguous.

Whenever statistical information is referred to in this specification, such statistical information may be obtained using any suitable manner, including but not limited to manual configuration (e.g., in the grammar or the knowledge base), frequency counts or other statistics based on whether parses subsequently become the best or fail, backpropagation-style learning, co-occurrence statistics, and machine learning methods.

Many variations of the above described embodiments will be available to one skilled in the art. In particular, some operations could be reordered, combined, or interleaved, or executed in parallel, and many of the data structures could be implemented differently. When one element, step, or object is specified, in many cases several elements, steps, or objects could equivalently occur. Steps in flowcharts could be implemented, e.g., as state machine states, logic circuits, or optics in hardware components, as instructions, subprograms, or processes executed by a processor, or a combination of these and other techniques.

The various components according to the various embodiments of the invention, including, e.g., the syntactic parser, non-disambiguated representation constructor, joint meaning disambiguator, word sense enumerator, reference enumerator, relation enumerator, combinator, and semantic evaluator, are preferably implemented using computer-executable program code means that are executed by one or more of the processors. However, any one of them might be implemented in silicon or other integrated circuit technology (whether electrical, optical, or something else). Hardware implementation may be particularly desirable in handheld devices where power consumption is very important. It is generally known in the art how to compile state machines (including recursive state machines) into silicon, and programs can be easily converted into such state machines.

What is claimed is:

1. A method comprising:
jointly disambiguating, by a computer, more than one ambiguous aspect of the meaning of a natural language expression;
wherein at least one of the ambiguous aspects relates to determining the referent of a constituent of the natural language expression.

2. The method of claim 1, wherein the computer comprises a joint meaning disambiguator and a reference enumerator, and the disambiguator and the enumerator are used in performing the disambiguating.

3. The method of claim 2, wherein the joint disambiguation comprises simultaneously disambiguating:
the referent of at least one constituent having reference ambiguity; and
at least one other ambiguous constituent;
wherein semantic information is used to find the jointly best interpretation for these ambiguities.

4. The method of claim 2, wherein the meaning representation of a reference to an individual comprises a pointer to an object in the knowledge base, and at least one ambiguous aspect relates to the selection of the object.

5. The method of claim 2, wherein at least one of the ambiguous aspects is the interpretation of a determiner.

6. The method of claim 2, wherein jointly disambiguating comprises:
enumerating more than one choice for each of the ambiguous aspects;
computing a weight for a plurality of combinations of choices, each combination comprising one choice for each of the ambiguous aspects and representing an alternative interpretation of the meaning; and
selecting at least one combination with the best weight, and for each selected combination using the choices in the combination to resolve ambiguous aspects of the meaning of the natural language expression.

7. The method of claim 6, wherein the weight is computed in part by evaluating the compatibility of the choices in the combination using semantic information.

8. The method of claim 2, wherein, for at least one enumerator, only a subset of the available choices are enumerated during the joint disambiguation.

9. The method of claim 2, wherein one of the enumerators uses an inference method for finding potential referents for an ambiguous constituent.

10. The method of claim 1, further comprising:
before disambiguation, constructing at least one non-disambiguated semantic representation of the meaning of the natural language expression, said representations together indicating said ambiguous aspects; and
after disambiguation, constructing at least one disambiguated semantic representation of the meaning of the natural language expression based on the disambiguated choices for the ambiguous aspects.

11. The method of claim 10, wherein, in constructing at least one disambiguated representation of the meaning, a disjunctive expression is created for representing the alternative interpretations of a constituent that could not be fully disambiguated.

12. The method of claim 1, wherein jointly disambiguating comprises evaluating a weight for a plurality of combinations of disambiguation choices using a semantic evaluator, wherein:
each combination comprises choices for at least two of said ambiguous aspects;
each combination comprises exactly one choice for each of the at least two of said ambiguous aspects; and
the choices for each of the at least two of said ambiguous aspects have been produced by enumerating at least two choices for the aspect.

13. The method of claim 12, wherein each enumeration is performed using an enumerator selected from the group consisting of: word sense enumerator, reference enumerator, and relation enumerator.

14. The method of claim 1, wherein the meaning includes an epistemic type for at least one entity, and at least one of the ambiguous aspects is the epistemic type of an entity referenced by a constituent of the natural language expression.

15. The method of claim 1, wherein at least one ambiguous aspect is the referent of an elliptic constituent.

16. The method of claim 1, wherein the meaning representation of an action comprises a pointer to an object representing the action, and at least one ambiguous aspect relates to selecting the object.

17. The method of claim 1, wherein two ambiguous aspects that have the same surface form in the natural language expression can be disambiguated to different meanings.

18. The method of claim 17, wherein each of the aspects corresponds to a constituent of the natural language expression, each constituent comprising at least one full word.

19. The method of claim 1, wherein at least one ambiguous aspect of the meaning relates to selecting of the proper argument for a logical predicate.

20. The method of claim 1, wherein at least one ambiguous aspect of the meaning relates to selecting the proper link type between nodes in a semantic network.

21. The method of claim 1, wherein at least one ambiguous aspect of the meaning relates to selecting the layout of a semantic network used to represent the meaning of the natural language expression or part thereof.

22. The method of claim 1, wherein at least one of the ambiguous aspects is the referent of a noun phrase.

23. The method of claim 1, wherein at least one of the ambiguous aspects is the referent of a verb phrase.

24. The method of claim 1, wherein at least one of the ambiguous aspects is a reference ambiguity, and selecting the appropriate referent uses a restrictive adjective, a prepositional phrase, or a restrictive relative clause to constrain the meaning of the ambiguous aspect.

25. The method of claim 1, wherein extralingual information is used in selecting the referent of a constituent which is one of the ambiguous aspects.

26. The method of claim 25, wherein the extralingual information comprises information obtained through vision about the direction or area pointed to by an agent.

27. The method of claim 1, wherein each of the ambiguous aspects belongs to a different category of ambiguous aspects selected from the group consisting of: word sense ambiguity, reference ambiguity of noun phrases, reference ambiguity of verb phrases, reference ambiguity of pronouns, determiner interpretation ambiguity, and relation interpretation ambiguity.

28. The method of claim 1, wherein the joint disambiguation selects the best interpretation for the ambiguous aspects based on deep semantic information.

29. The method of claim 28, wherein the deep semantic information comprises information about the typical sequence of events in the kind of situation that is the topic of the natural language expression.

30. The method of claim 28, wherein the deep semantic information comprises information about the intellectual capabilities of the various agents and objects belonging to the context of the natural language expression.

31. The method of claim 28, wherein the deep semantic information comprises information about what the other party in the conversation that the natural language expression belongs to knows.

32. The method of claim 1, wherein the joint disambiguation selects the best interpretation for the ambiguous aspects in part by applying a semantic constraint to the choices for more than ambiguous aspect simultaneously.

33. The method of claim 32, wherein at least one semantic constraint specifies allowable thematic roles for a noun.

34. The method of claim 32, wherein at least one semantic constraint specifies what kind of nouns an adjective may characterize.

35. The method of claim 32, wherein at least one semantic constraint limits the combinations of verbs with adverbials.

36. The method of 1, wherein at least one ambiguous aspect is partially disambiguated.

37. The method of 36, wherein at least some choices for an ambiguous aspect are arranged into a hierarchy of choices, and intermediate nodes in the hierarchy are possible partial disambiguations for the ambiguous aspect.

38. The method of claim 1, wherein the application of joint disambiguation is controlled by the grammar.

39. The method of 38, wherein the grammar causes joint disambiguation to be performed in a nested fashion for parts of the same natural language expression.

40. The method of 1, wherein the joint disambiguation adjusts the weight of a combination of choices in more than one place.

41. The method of 1, further comprising:
pruning the generation of combinations in response to determining that the weight of any combination resulting from a branch of the generation process cannot become sufficient for it to be selected as one of the best combinations.

42. A method comprising:
reading and preprocessing, by a computer, a natural language expression from an input;
parsing, by the computer, the natural language expression or part thereof, creating a preliminary semantic representation of its meaning, said representation comprising more than one ambiguity;
disambiguating, by the computer, ambiguities in the preliminary semantic representation; and
constructing, by the computer, a semantic representation of the meaning of the natural language expression, wherein at least some of the ambiguities of the preliminary semantic representation have been resolved;
wherein the improvement comprises performing the disambiguation by jointly disambiguating more than one of the ambiguities.

43. The method of claim 42, wherein the computer comprises a joint meaning disambiguator used for the joint disambiguation.

44. The method of claim 43, wherein jointly disambiguating comprises resolving the reference of at least one constituent of the natural language expression using particular choices for other ambiguities and semantic information to constrain the possible referents.

45. The method of claim 42, wherein at least one of the ambiguities is the referent of a pronoun.

46. The method of claim 42, wherein jointly disambiguating more than one ambiguity comprises:
generating combinations of choices, each combination comprising one choice for each of the ambiguities; and
evaluating at least one of the combinations using semantic information such that the weight computed for a combination depends on more than one choice.

47. An apparatus comprising:
a joint meaning disambiguator (115) comprising:
at least one reference enumerator (117);
at least one combinator (119) coupled to at least one of the reference enumerators for receiving choices from the reference enumerator; and
at least one semantic evaluator (120) configured to compute a weight for at least one combination generated by at least one of the combinators.

48. The apparatus of claim 47, wherein the apparatus is a computer.

49. The apparatus of claim 48, wherein the joint meaning disambiguator comprises:
a relation enumerator; and
a word sense enumerator.

50. The apparatus of claim 47, wherein the apparatus is a robot equipped with a natural language interface implemented in part using the joint meaning disambiguator.

51. The apparatus of claim 47, wherein the apparatus is a home, business, or mobile appliance equipped with a natural language interface implemented in part using the joint meaning disambiguator.

52. A computer comprising:
a means for parsing a natural language expression; and
a means for jointly disambiguating at least two ambiguous aspects of the meaning of the parsed natural language expression.

53. The computer of claim 52, further comprising:
a means for enumerating choices for the referent of a constituent of the natural language expression for use in the means for jointly disambiguating.

54. The computer of claim 53, further comprising:
a means for semantically evaluating combinations of choices from different enumerations.

55. A computer program product stored on a tangible computer readable medium, operable to cause a computer to jointly disambiguate more than one ambiguous aspect of the meaning of a natural language expression, the product comprising:
a computer executable program code means for parsing a natural language expression; and
a computer executable program code means for jointly disambiguating more than one ambiguous aspect of the meaning of the parsed natural language expression.

56. The computer program product of claim 55, further comprising:
a computer executable program code means for enumerating choices for the referent of a constituent of a natural language expression, the referent being one of the ambiguous aspects.

57. The computer program product of claim 56, further comprising:
a computer executable program code means for semantically evaluating combinations of enumerated choices for the ambiguous aspects.
